(19) United States
(12) Patent Application Publication
(10) Pub. No.: US 2016/0196022 A1
(43) Pub. Date: Jul. 7, 2016

(54) INFORMATION PROCESSING APPARATUS, CONTROL METHOD, AND STORAGE MEDIUM

(71) Applicant: CANON KABUSHIKI KAISHA, Ohta-ku, Tokyo (JP)

(72) Inventor: Kenta Matsui, Moriya-shi (JP)

(21) Appl. No.: 14/911,864

(22) PCT Filed: Oct. 2, 2014
(86) PCT No.: PCT/JP2014/005037

§ 371 Date: Feb. 12, 2016

(30) Foreign Application Priority Data
Oct. 9, 2013 (JP) 2013-212228

(51) Int. Cl. G06F 3/0483; G06F 3/0488; G06F 3/0486

(52) U.S. Cl. CPC G06F 3/0483; G06F 3/0486; G06F 3/0488

(57) ABSTRACT

Provided is an information processing apparatus including a touch panel. A first information processing apparatus includes an accepting unit configured to accept a touch operation to switch a page of a content displayed on the first touch panel, and a controlling unit configured to switch the page of the content displayed on the first touch panel in accordance with accepting the touch operation by the accepting unit and to transmit information to a second information processing apparatus including a second touch panel for switching a page of a content displayed on the second touch panel.

### TECHNICAL FIELD

The present invention relates to an information processing apparatus, a control method, and a storage medium.

### BACKGROUND ART

Information processing apparatuses provided with a touch panel such as tablet terminal are widely used. In such a tablet terminal, any content is displayed on a screen and the content is operable by performing operations on the display screen. To improve the operability, there is an information processing apparatus which changes the operation content in accordance with a number of fingers in contact with the touch panel (Patent Literature 1).

### CITATION LIST

### Patent Literature

Patent Literature 1: Patent Application Laid-Open No. 11-102274

A screen included in an information processing apparatus such as tablet terminal and the like is provided in a size that takes into consideration being carried. For example, when a user checks or compares two contents at the same time, a display size of each content becomes small and thereby visibility is low in such screen size. Thus, it is contemplated that two information processing apparatuses are prepared and one information processing apparatus displays one content and other information processing apparatus displays other content. However, when the user performs some operation on the contents, the user must perform operations on each of the two information processing apparatuses. The present invention provides an information processing system that connects a plurality of information processing apparatuses and displays the contents, and cooperatively processes in accordance with the user's operation on the contents.

### SUMMARY OF INVENTION

According to an aspect of the present invention, an information processing system is provided in which a plurality of information processing apparatuses that include touch panels communicate each other. A first information processing apparatus includes an accepting unit configured to accept a touch operation to switch a page of a content displayed on the first touch panel, and a controlling unit configured to switch the page of the content displayed on the first touch panel in accordance with the acceptance of the touch operation by the accepting unit and to transmit information to a second information processing apparatus including a second touch panel for switching a page of a content displayed on the second touch panel.

According to the present invention, an information processing system that is capable of connecting a plurality of information processing apparatuses and displaying the contents, and cooperatively processing in accordance with the user's operation may be provided.

Further features of the present invention will become apparent from the following description of exemplary embodiments with reference to the attached drawings.

### BRIEF DESCRIPTION OF DRAWINGS

FIG. 1 illustrates an exemplary hardware configuration of the information processing apparatus according to the present invention.

FIG. 2A illustrates an exemplary software configuration operating on each of the information processing apparatuses.

FIG. 2B illustrates an exemplary software configuration operating on each of the information processing apparatuses.

FIG. 3 is a flowchart illustrating the operation of a master side device according to a first embodiment.

FIG. 4 is a flowchart illustrating the operation of a slave side device according to the first embodiment.

FIG. 5 is a flowchart illustrating the operation of a master side device according to a second embodiment.

FIG. 6 is a flowchart illustrating the operation of a slave side device according to the second embodiment.

FIG. 7 is a flowchart illustrating the operation of a master side device according to a third embodiment.

FIG. 8 is a flowchart illustrating the operation of a slave side device according to the third embodiment.

FIG. 9A illustrates a state of a connection of the information processing apparatus according to a first embodiment.

FIG. 9B illustrates the state of the connection of the information processing apparatus according to the first embodiment.

FIG. 10A illustrates a state of a connection of the information processing apparatus according to a second embodiment.

FIG. 10B illustrates the state of the connection of the information processing apparatus according to the second embodiment.

FIG. 11A illustrates an operation example according to a first embodiment and its result.

FIG. 11B illustrates an operation example according to the first embodiment and its result.

FIG. 12A illustrates an operation example according to a second embodiment and its result.

FIG. 12B illustrates an operation example according to the second embodiment and its result.

FIG. 13 illustrates an operation example according to a third embodiment and its result.

### DESCRIPTION OF EMBODIMENTS

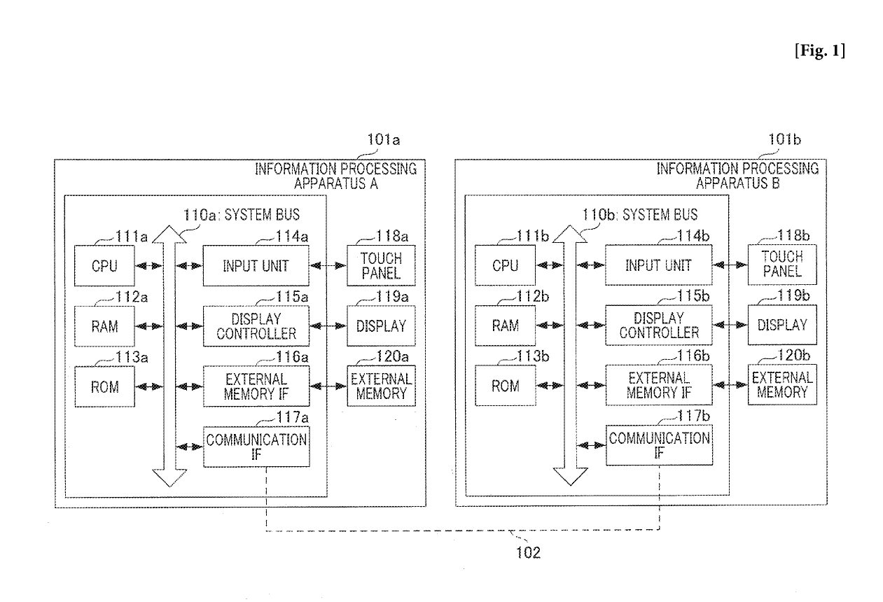

FIG. 1 illustrates an exemplary configuration of an information processing system according to the present invention. FIG. 1 illustrates a state of connection between an hardware configuration of information processing apparatus 101a (hereinafter referred to as “information processing apparatus A”) and a hardware configuration of an information processing apparatus 101b (hereinafter referred to as “information processing apparatus B”) to which the present embodiment according to the present invention is applicable. The information processing apparatus A includes CPU 111a, RAM 112a, ROM 113a, input unit 114a, display controller 115a, external memory IF 116a, and communication IF 117a. CPU 111a to communication IF 117a are connected to a system bus 110a and are configured to transmit data to each other. The information processing apparatus A also includes touch panel 118a, display 119a, and external memory 120a. The information processing apparatus B has the same configuration as information processing apparatus A. Thus, the description of the information processing apparatus A is made below and that of the information processing apparatus B is omitted.

The CPU 111a (Central Processing Unit) controls each unit of the information processing apparatus A, for example, according to a program stored in the ROM 113a using the RAM 112a as a work memory. The RAM 112a (Random Access Memory) is a volatile memory, and is used as a main memory of CPU 111a and as a work memory or the like of temporary storage device. The ROM 113a (Read Only Memory) is a non-volatile memory, and image data or other data, various programs for operating CPU 111a or the like are stored respectively in a predetermined area. Note that the programs to operate CPU 111a are not only stored in the ROM 113a, but also are previously stored in the external memory 120a as hard disk or the like.

The input unit 114a accepts a user operation via the touch panel 118a, generates a control signal according to the user operation, and transmits the control signal to CPU 111a. The touch panel 118a is formed, for example, into a planar shape and is a pointing device that can output a coordinate according to the position contacted. CPU 111a uses the control signal generated by the input unit 114a according to the user operation on the touch panel 118a, and thereby controls each unit of the information processing apparatus A. Consequently, an operation according to the user operation can be performed to the information processing apparatus A.

The display controller 115a outputs a display signal for displaying an image to a display 119a. For example, the display controller 115a generates a display signal based on an execution of a program by CPU 111a and displays a GUI screen configuring a GUI (Graphical User Interface) to a display 119a.

The touch panel 118a is integrally configured with the display 119a. For example, the touch panel 118a is configured such that a light transmittance does not prevent a display of the display 119 and is attached on an upper layer of a display surface of the display 119. An input coordinate of the touch panel 118a is associated with a display coordinate of the display 119a. Consequently, the GUI can be configured as if the user can operate a screen displayed on the display 119 directly.

A detachable external memory 120a such as hard disk or memory card or the like may be attached to the external memory IF 116a. The external memory IF 116a reads data from the attached external memory 120a or writes data to the external memory 120a based on the control of the CPU 111a. The communication IF 117a communicates with, for example, the communication IF 117b of the information processing apparatus B by performing communication through various networks 102 such as wire or wireless or the like, based on the control of the CPU 111a.

Examples of an operation or states of the touch panel 118a are as follows: touching the touch panel with a finger or a pen (hereinafter referred to as “touch-down”); a state touching the touch panel with a finger or a pen on a fixed position without moving (hereinafter referred to as “touch-on”); moving a finger or a pen while touching the touch panel (hereinafter referred to as “move”); removing a finger or a pen that has been touching the touch panel (hereinafter referred to as “touch-up”); and a state in which nothing is touching the touch panel (hereinafter referred to as “touch-off”).

These operations and position coordinates of a finger or a pen touching the touch panel are reported to the CPU 111a through the system bus 110a. The CPU 111a determines what operation was performed on the touch panel based on the reported information. With respect to the “move”, a movement direction of a finger or a pen that moves on the touch panel is determined for each vertical and horizontal component of the touch panel based on a change of a position coordinate. It is assumed that a stroke is drawn when a touch-up has occurred after a predetermined “move”.

An operation drawing a stroke quickly is called “flick”. The “flick” is an operation such that a finger moves quickly by a certain distance while touching the touch panel and then the finger is removed. In other words, the “flick” is an operation of a snapping stroke in which the touch panel quickly with a finger. The CPU 111a determines that the “flick” is performed when the “move” of predetermined distance or more and of predetermined velocity or more is detected, and then the “touch-up” is detected. When the “move” of predetermined distance or more is detected and then the “touch-on” is detected, it is determined that a “drag” is performed. When the “move” is not detected after the “touch-down” is detected and is in a state that “touch-on” is detected, it is determined that a “hold” is being performed.

The touch panel 118a may use any system from various systems of touch panels such as resistance film system, electrostatic capacitance system, surface acoustic wave system, infrared ray system, electromagnetic induction system, image recognition system, optical sensor system, and the like.

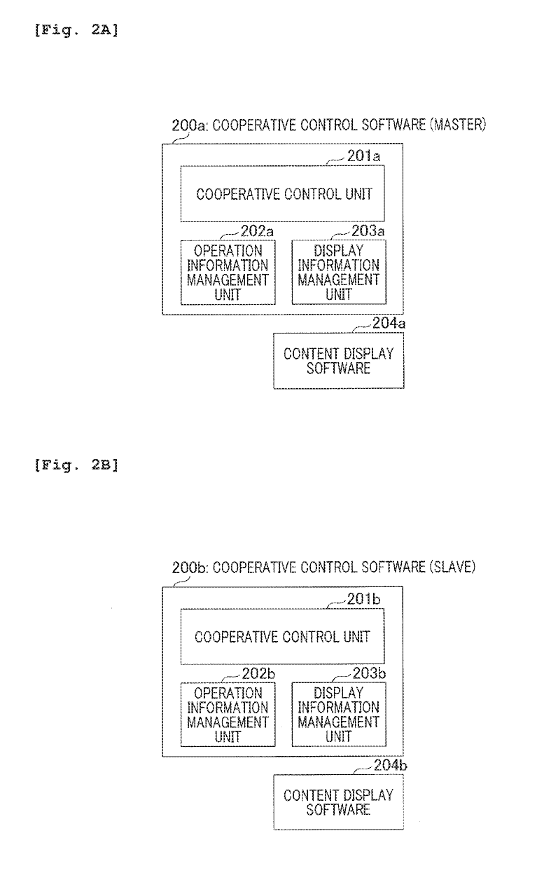

FIGS. 2A and 2B are diagrams each illustrating a module configuration of the software which are each operated by the CPU 111a of the information processing apparatus A and the CPU 111b of the information processing apparatus B according to the embodiment of the present invention. The information processing apparatus A includes a cooperative control software 200a and a content display software 204a. The cooperative control software 200a includes a cooperative control unit 201a, an operation information management unit 202a, and a display information management unit 203a. Likewise, the information processing apparatus B includes cooperative control software 200b and content display software 204b. The cooperative control software 200b includes a cooperative control unit 201b, an operation information management unit 202b, and a display information management unit 203b.

The cooperative control software 200a operated by the CPU 111a and the cooperative control software 200b operated by the CPU 111b have master-slave relation in order to link and cooperatively operate the information processing apparatus A and the information processing apparatus B. Either can be the master but here, the description will be given in which the cooperative control software 200a serves as the master device and the cooperative control software 200b serves as the slave device. In other words, any one of a plurality of information processing apparatuses may function as the master device and the other information processing apparatuses besides the master device function as the slave devices. Note that a master device indicates a device which controls one or more processes of the other cooperative devices unilaterally. And a slave device indicates a device which one or more processes are controlled by a cooperative master device.

The content display software 204a operated by the CPU 111a and the content display software 204b operated by the CPU 111b perform display of arbitrary contents. The cooperative control software 200a can perform various controls over the content display software 204a, including starting the content display software 204a. Likewise, the cooperative control software 200b can perform various controls over the content display software 204b.

The master operation information management unit 202a is a module for grasping operation information of a user input from the touch panel 118a and for performing management of the operation information of the user. On the other hand, the slave operation information management unit 202b is a module for grasping operation information of a user input from the touch panel 118b and for performing management of the operation information of the user.

The master cooperative control unit 201a and the slave cooperative control unit 201b include cooperative function and can transmit or receive each other's operation information. For example, the master cooperative control unit 201a can transmit the operation information acquired from the operation information management unit 202a to the communication IF 117b via the communication IF 117a.

The master cooperative control unit 201a transmits the operation information acquired from the operation information management unit 202a or the operation information received from the cooperative control unit 201b to the display information management unit 203a. The display information management unit 203a reflects the operation information transmitted from the cooperative control unit 201a in the content display software 204a and the content display software 204a updates the content of a display content in accordance with the operation information.

The slave cooperative control unit 201b transmits the operation information received from the cooperative control unit 201a to the display information management unit 203b. The display information management unit 203b reflects the operation information transmitted from the cooperative control unit 201b in the content display software 204b and the content display software 204b updates the content of a display content in accordance with the operation information. The above-described configuration enables the information processing apparatus A and the information processing apparatus B to perform a cooperative process.

### First Embodiment

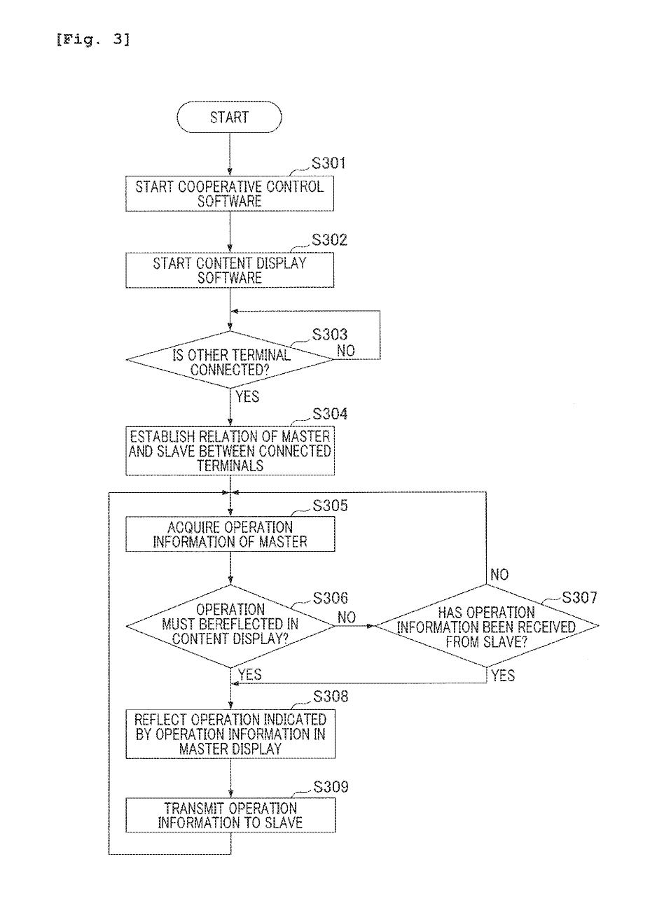

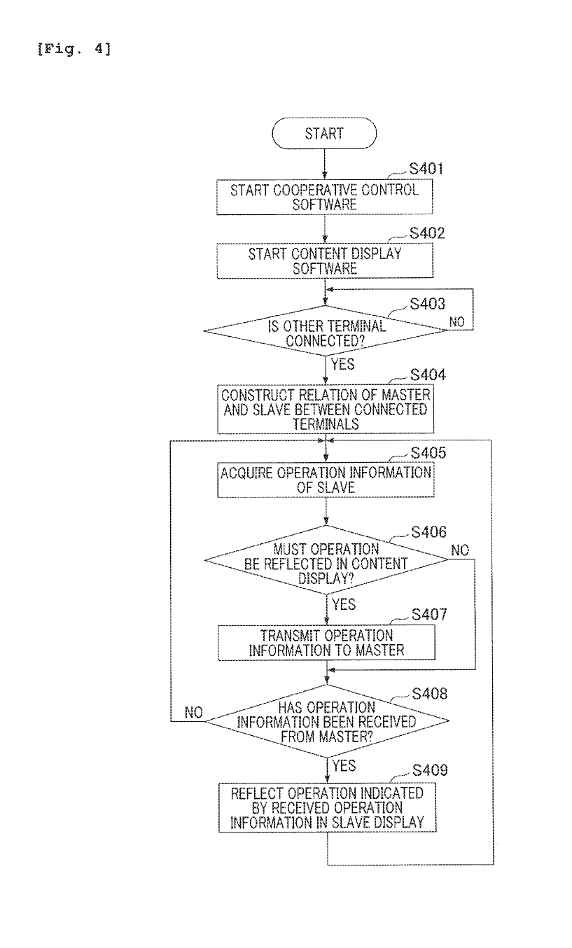

FIG. 3 is a flowchart illustrating an operation of the information processing apparatus A (101a) serving as a master in the present embodiment. FIG. 4 is a flowchart illustrating an operation of the information processing apparatus B (101b) serving as a slave in the present embodiment. For convenience of explanation, the master cooperative control software 200a is executed by the CPU 111a of the information processing apparatus A and the slave cooperative control software 200b is executed by the CPU 111b of the information processing apparatus B.

In step S301, the CPU 111a starts the cooperative control software 200a. Whether the start is programmed in advance when supplying power to the information processing apparatus A or the start is by a user's instruction does not matter. In step S302, the CPU 111a starts the content display software 204a and displays the content of the contents. The software to be started and the contents to be displayed are supposed to be selected by the user.

In step S303, CPU 111a confirms whether or not other information processing apparatuses are connected. Although, in the present embodiment, Bluetooth® is used for a method for confirming a connection, the method is not limited thereto. When the information processing apparatus A and the information processing apparatus B are connected by Bluetooth® for the first time, an operation called pairing, which specifies a connected opposite side and inputs a same authentication key in both the information processing apparatuses A and the information processing apparatus B, is necessary. In the present embodiment, it is assumed that such pairing has been already performed. When the connection with the information processing apparatus B is confirmed, the operation proceeds to step S304. When the connection with the information processing apparatus B is not confirmed, the operation of the step S303 is repeated.

In step S304, the cooperative control unit 201a performs communication with the cooperative control unit 201b of the connection destination and determines the roles of the master and the slave. In the present embodiment, the information processing apparatus which started the content display software earlier becomes the master. Here, it is assumed that the information processing apparatus A started the content display software before the information processing apparatus B. Therefore, here, the cooperative control unit 201a becomes the master. In other words, here, the cooperative control unit 201 determines whether which information processing apparatus of the own apparatus and the other apparatus is the master device or which information processing apparatus of the own apparatus and the other apparatus is the slave device, in accordance with whether which information processing apparatus of the own apparatus and the other apparatus has accepted the content display instruction earlier. In step S305, the cooperative control unit 201a acquires the operation information of the operation information management unit 202a.

In step S306, the cooperative control unit 201a determines whether or not the acquired operation information is an operation that must be reflected in the content display. The term “operation that must be reflected in the content display” means the operation which changes the display content of the content display software by an operation such as the flick operation which turns the content page, the drag operation which moves the content, or the pinch operation which magnifies or reduces the content. An operation which does not change the display content, such as the touch-on operation in which the finger is just touching the touch panel, is an operation not required to be reflected in the content display. Not only the flick, drag, and pinch are the operations that must be reflected in the content display, but also any other operations that change the display content of the content display software such as rotation or the like are the target operations must be reflected in the content display. If the acquired operation information is the operation that must be reflected in the content display, the operation proceeds to step S308. If the acquired operation information is not the operation required to be reflected in the content display, the operation proceeds to step S307.

In step S307, the cooperative control unit 201a confirms whether the operation information is received from the slave cooperative control unit 201b of the connection destination. In other words, the cooperative control unit 201a receives the information in relation to the process from the other information processing apparatus, during connection with the other information processing apparatus, in accordance with the operation instruction of the screen provided in the other information processing apparatus. Since the description will be given of the operation to which the slave cooperative control unit 201b transmits the operation information in the flowchart shown in FIG. 4, the explanation thereof will be omitted. When the operation information has been received from the cooperative control unit 201b, the operation proceeds to step S308. When the operation information has not been received from the cooperative control unit 201b, the operation returns to step S305.

In step S308, the cooperative control unit 201a transmits the operation information acquired in step S305 or received in step S307 to the display information management unit 203a. The display information management unit 203a reflects the transmitted operation information in the content display software 204a. The operation of the present step enables the content display software 204a which operates on the information processing apparatus A to be reflected the operation of both information processing apparatuses A and B.

In step S309, the cooperative control unit 201a transmits the operation information acquired in step S305 or received in step S307 to the slave cooperative control unit 201b of the connection destination. The slave cooperative control unit 201b operates in accordance with the operation information received from the master cooperative control unit 201a, rather than operate immediately in accordance with the operation information acquired from the slave operation information management unit 202b. Thus, in the present step, the operation information received from the slave is also transmitted to the slave as the operation information transmitted from the master.

A description will be given for the operation of the slave information processing apparatus B (101b) with reference to the flowchart shown in FIG. 4. In step S401, the CPU 111b starts the cooperative control software 200b. Whether a start is programmed in advance when supplying power to the information processing apparatus B or a start is by a user's instruction does not matter. In step S402, the CPU 111b starts the content display software 204b and displays the content of the contents. The software to be started and the contents to be displayed are supposed to be selected by the user.

In step S403, the CPU 111b confirms whether or not other information processing apparatuses are connected. As described in step S303 shown in FIG. 3, Bluetooth® is used for a method for confirming a connection and the pairing of the information processing apparatus A and the information processing apparatus B has been already performed. When the connection with the information processing apparatus A (101a) is confirmed, the operation proceeds to step S404. When the connection with the information processing apparatus A (101a) is not confirmed, the operation of the step S403 is repeated.

In step S404, the cooperative control unit 201b performs communication with the cooperative control unit 201a of the connection destination and determines the roles of the master and slave. In the present embodiment, the information processing apparatus which started the content display software earlier becomes the master. As described in step S304 shown in FIG. 3, here the cooperative control unit 201a becomes the master and the cooperative control unit 201b becomes the slave.

In step S405, the cooperative control unit 201b acquires the operation information of the operation information management unit 202b. In step S406, the cooperative control unit 201b determines whether or not the acquired operation information is an operation must be reflected in the content display. The operations that must be reflected in the content display or not to be reflected is as described in step S306 shown in FIG. 3. If the acquired operation information is the operation that must be reflected in the content display, the operation proceeds to step S407. If the acquired operation information is not the operation required to be reflected in the content display, the operation proceeds to step S408.

In step S407, the cooperative control unit 201b transmits the operation information acquired in step S406 to the master cooperative control unit 201a of the connection destination. The operation information transmitted by the cooperative control unit 201b in the present step is received by the cooperative control unit 201a in step S307 shown in FIG. 3. In step S408, the cooperative control unit 201b confirms whether the operation information is received from the master cooperative control unit 201a of the connection destination. The operation information transmitted by the cooperative control unit 201a in step S309 shown in FIG. 3 is received by the cooperative control unit 201b in the present step. If the operation information has been received from the cooperative control unit 201a, the operation proceeds to step S409. If the operation information has not been received from the cooperative control unit 201a, the operation returns to step S405.

In step S409, the cooperative control unit 201b transmits the operation information received in step S408 to the display information management unit 203b. The display information management unit 203b reflects the transmitted operation information in the content display software 204b. The operation of the present step enables the content display software 204b which operates on the information processing apparatus B to be reflected the operation of both information processing apparatuses A and B.

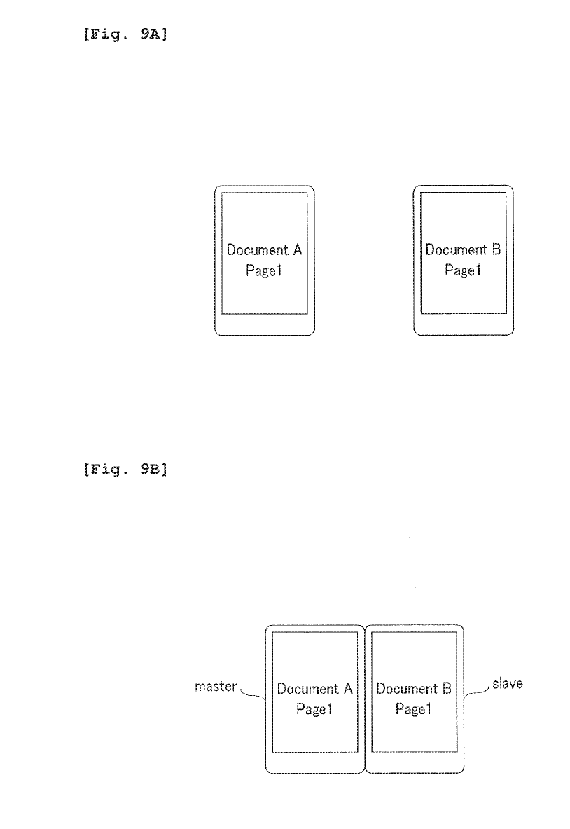

FIGS. 9A and 9B illustrate the state of the connection between the information processing apparatus A and the information processing apparatus B in the present embodiment. FIG. 9A illustrates a state before the relation of the master and the slave has been established. Each of the cooperative control software (200a and 200b) has been started. Also, the information processing apparatus A and the information processing apparatus B have started the content display software (204a and 204b), and respectively display page 1 of the document A and page 1 of the document B.

FIG. 9B illustrates a state after the relation of the master and the slave has been established. By the operation of the cooperative control software (200a and 200b), the information processing apparatus A becomes the master and the information processing apparatus B becomes the slave.

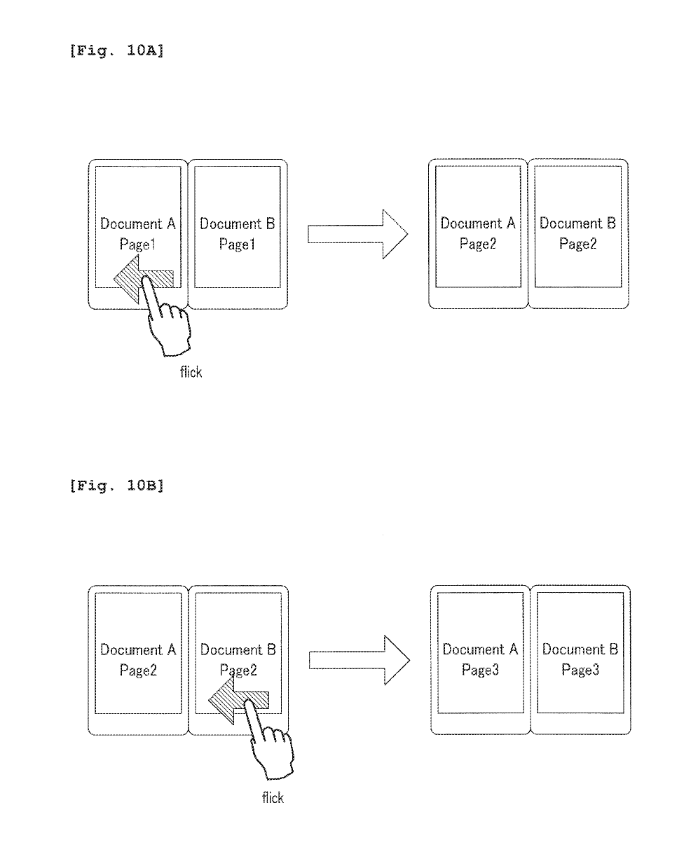

FIGS. 10A and 10B illustrate an exemplary operation of the information processing apparatus A and the information processing apparatus B of the state shown in FIG. 9B according to the present embodiment, and a result thereof. If the user performs the flick operation, which turns the page, on the master information processing apparatus A, the operation is reflected in both the information processing apparatuses A and the information processing apparatus B, and thereby page 2 of document A is displayed in the information processing apparatus A and page 2 of document B is displayed in the information processing apparatus B (FIG. 10A). Subsequently, if the user performs the flick operation, which turns the page, to the slave information processing apparatus B, the operation is reflected, likewise as above, in both the information processing apparatuses A and the information processing apparatus B, and thereby page 3 of document A is displayed in the information processing apparatus A and the page 3 of the document B is displayed in the information processing apparatus B (FIG. 10B). In the present embodiment, each of the information processing apparatuses displays the page following the displayed page by the flick operation, but naturally in accordance with the flick operation, the previous page may be displayed.

The above-described processing enables a plurality of information processing apparatuses to be connected and display contents, and perform cooperative processes in accordance with a user operation on the contents. According to the present embodiment, when the user confirms and compares two contents simultaneously using two information processing apparatuses, the user does not need to perform the operation of turning pages of the information processing apparatuses respectively. Furthermore, the operation of turning pages can be performed to either of the information processing apparatuses, so that an information processing apparatus system with high operability can be provided.

### Second Embodiment

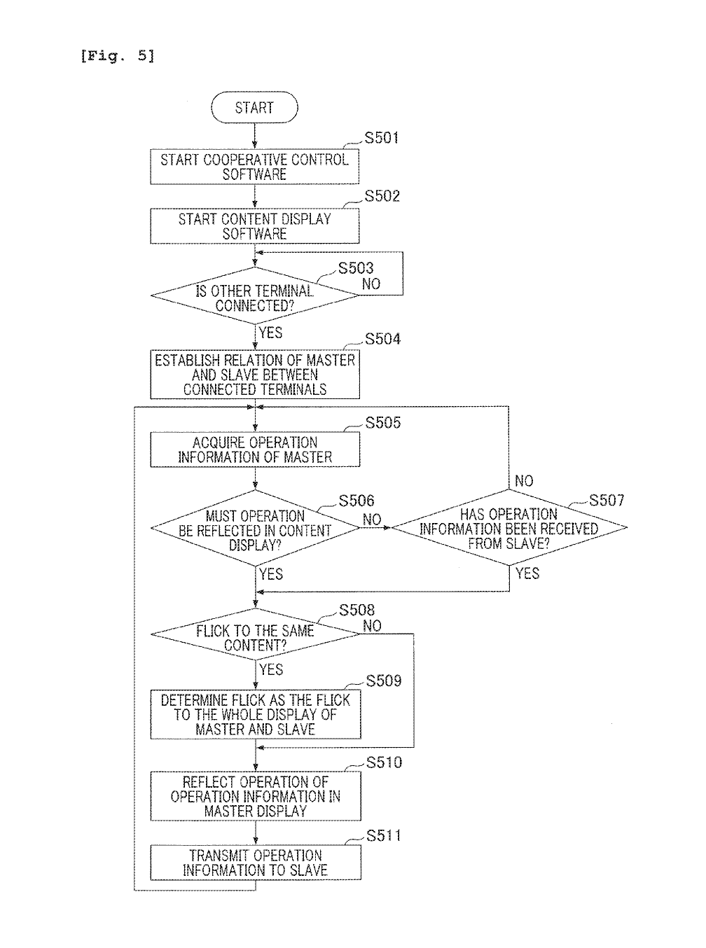

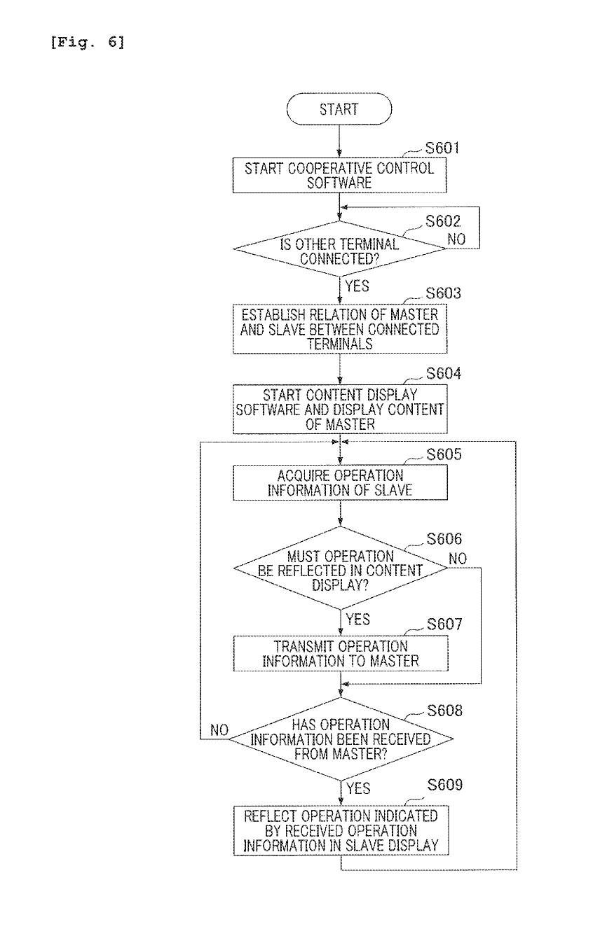

FIG. 5 is a flowchart illustrating the operation of the information processing apparatus A (101a), which is the master in the present embodiment. FIG. 6 is a flowchart illustrating an operation of the information processing apparatus B (101b), which is the slave in the present embodiment. For convenience of explanation as with the first embodiment, the master cooperative control software 200a is executed by the CPU 111a of the information processing apparatus A and the slave cooperative control software 200b is executed by the CPU 111b of the information processing apparatus B.

In step S501, CPU 111a starts the cooperative control software 200a. Whether a start is programmed in advance when supplying power to the information processing apparatus A or a start is by a user's instruction does not matter. In step S502, the CPU 111a starts the content display software 204a and displays the content of the contents. The software to be started and the contents to be displayed are supposed to be selected by the user.

In step S503, CPU 111a confirms whether other information processing apparatus is connected or not. As with the first embodiment, the Bluetooth® is used for a method for confirming a connection. When the connection with the information processing apparatus B (101b) is confirmed, the operation proceeds to step S504. When the connection with the information processing apparatus B (101b) is not confirmed, the operation of the step S503 is repeated.

In step S504, the cooperative control unit 201a performs communication with the cooperative control unit 201b of the connection destination and determines the roles of the master and the slave. As with the first embodiment, the information processing apparatus which started the content display software earlier becomes the master, but in the present embodiment, the information processing apparatus B (101b) is in the state that the content display software 204b has not been started. Thus, as a specification, the information processing apparatus that has started the content display software becomes the master and the information processing apparatus that has not started the content display software becomes the slave. According to the specification, the master and the slave are determined. Alternatively, the user may select the master and the slave. Here, according to the specification, it is assumed that the cooperative control unit 201a is the master. The cooperative control unit 201a instructs the cooperative control unit 201b of the connection destination to start the content display software and to display a content which corresponds to the content displaying on the own apparatus.

In step S505, the cooperative control unit 201a acquires the operation information of the operation information management unit 202a. In step S506, the cooperative control unit 201a determines whether the acquired operation information is an operation that must be reflected in the content display or not. If the acquired operation information is the operation that must be reflected in the content display, the operation proceeds to step S508. If the acquired operation information is not the operation required to be reflected in the content display, the operation proceeds to step S507.

In step S507, the cooperative control unit 201a confirms whether the operation information is received from the slave cooperative control unit 201b of the connection destination. Since the description will be given of the operation to which the slave cooperative control unit 201b transmits the operation information in the flowchart shown in FIG. 6, the explanation thereof will be omitted. When the operation information has been received from the cooperative control unit 201b, the operation proceeds to step S508. When the operation information has not been received from the cooperative control unit 201b, the operation returns to step S505.

In step S508, the cooperative control unit 201a confirms whether the operation information acquired in step S505 is a flick operation, which turns the page, or not. Also, the cooperative control unit 201a confirms whether the master and the slave are displaying the same content or not. If the master and the slave are displaying the same content and the operation information is the flick operation, then the operation proceeds to step S509. Otherwise, the operation proceeds to step S510.

In step S509, the cooperative control unit 201a determines that the flick operation is a flick operation to the whole display of the master and the slave. It is assumed that the information processing apparatus A is displaying page 1 of the document A and the information processing apparatus B is displaying page 2 of the same document A. As in the case of usual flick operation so far, the page of each of the information processing apparatuses is turned, and the information processing apparatus A displays page 2 of the document A and the information processing apparatus B displays page 3 of the document A. However, in the case of the flick operation to the whole display of the master and the slave, the information processing apparatus A displays page 3 of the document A and the information processing apparatus B displays page 4 of the document A. In other words, the operation is as if the page of a book is turned.

In order to realize the operation to the whole display of the master and the slave, in this step, the operation information acquired in step S505 or received in step S507 is changed to information that repeats twice the operation indicated by the operation information (=flick operation). In step S510, the cooperative control unit 201a transmits the operation information to the display information management unit 203a. The display information management unit 203a reflects the transmitted operation information to the content display software 204a. The operation of the present step enables the content display software 204a, which operates on the information processing apparatus A, to be reflected the operation of both information processing apparatuses A and B. In step S511, the cooperative control unit 201a transmits the operation information to the slave cooperative control unit 201b of the connection destination.

Next, a description will be given for the operation of the slave information processing apparatus B (101b) with reference to the flowchart shown in FIG. 6. In step S601, CPU 111b starts the cooperative control software 200b. Whether a start is programmed in advance when supplying power to the information processing apparatus B or a start is by a user's instruction does not matter. In step S602, the CPU 111b confirms whether or not other information processing apparatus is connected. As described in the first embodiment, Bluetooth® is used for a method for confirming a connection. When the connection with the information processing apparatus A (101a) is confirmed, the operation proceeds to step S603. When the connection with the information processing apparatus A (101a) is not confirmed, the operation of the step S602 is repeated.

In step S603, the cooperative control unit 201b performs communication with the cooperative control unit 201a of the connection destination and determines the roles of the master and the slave. Here, as described in step S504 shown in FIG. 5, the cooperative control unit 201a becomes the master and the cooperative control unit 201b becomes the slave.

In step S604, the cooperative control unit 201b starts the content display software 204b. The cooperative control unit 201b requests displaying the content corresponding to the content which the content display software 204a displays on the master information processing apparatus A, to the content display software 204b. If a plurality of pages are included in the content, the cooperative control unit 201b requests displaying the next page of which the content display software 204a is displaying. In step S605, the cooperative control unit 201b acquires the operation information of the operation information management unit 202b.

In step S606, the cooperative control unit 201b determines whether or not the acquired operation information is an operation that must be reflected in the content display. If the acquired operation information is the operation must be reflected in the content display, the operation proceeds to step S607. If the acquired operation information is not the operation is not required to be reflected in the content display, the operation proceeds to step S608. In step S607, the cooperative control unit 201b transmits the operation information acquired in step S605 to the master cooperative control unit 201a of the connection destination. The operation information transmitted by the cooperative control unit 201b in the present step is received by the cooperative control unit 201a in step S507 shown in FIG. 5.

In step S608, the cooperative control unit 201b confirms whether the operation information has been received from the master cooperative control unit 201a of the connection destination. The operation information transmitted by the cooperative control unit 201a in step S511 shown in FIG. 5 is received by the cooperative control unit 201b in the present step. If the operation information has been received from the cooperative control unit 201a, the operation proceeds to step S609. If the operation information has not been received from the cooperative control unit 201a, the operation returns to step S605.

In step S609, the cooperative control unit 201b transmits the operation information received in step S608 to the display information management unit 203b. The display information management unit 203b reflects the transmitted operation information in the content display software 204b. The operation of the present step enables the content display software 204b which operates on the information processing apparatus B to be reflected the operation of both information processing apparatuses A and B.

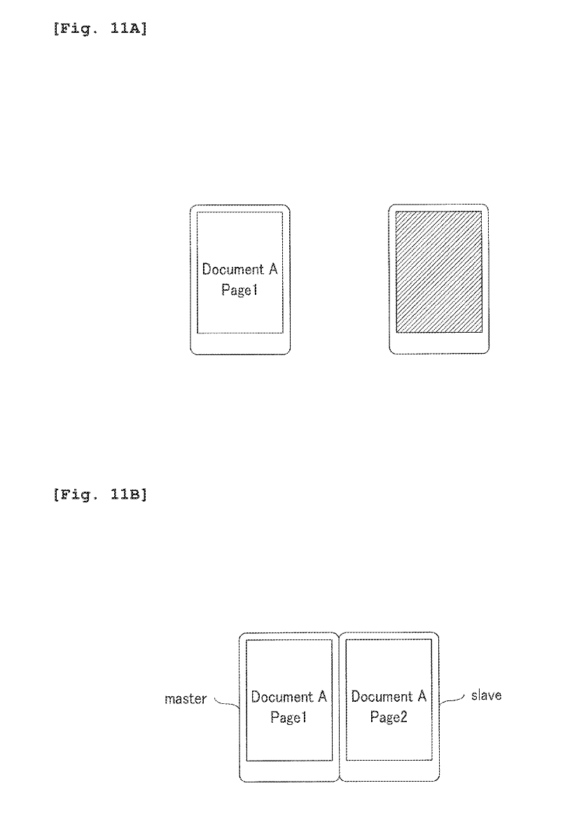

FIGS. 11A and 11B illustrate the state of the connection between the information processing apparatus A (101a) and the information processing apparatus B (101b) in the present embodiment. FIG. 11A illustrates a state before the relation of the master and the slave is constructed. Each of the cooperative control software (200a and 200b) has been started. Also the information processing apparatus A has started the content display software 204a and displays page 1 of the document A. The information processing apparatus B has not started the content display software 204b.

FIG. 11B illustrates a state immediately after the relation of the master and the slave is constructed. By the operation of the cooperative control software (200a and 200b) in step S504, the information processing apparatus A becomes the master and the information processing apparatus B becomes the slave. By the connection, the information processing apparatus B has started the content display software 204b. As the information processing apparatus A is displaying page 1 of the document A, the information processing apparatus B displays page 2, which is the next page, of the document A. In other words, FIG. 11B illustrates the state in which the content is displayed in a spread state.

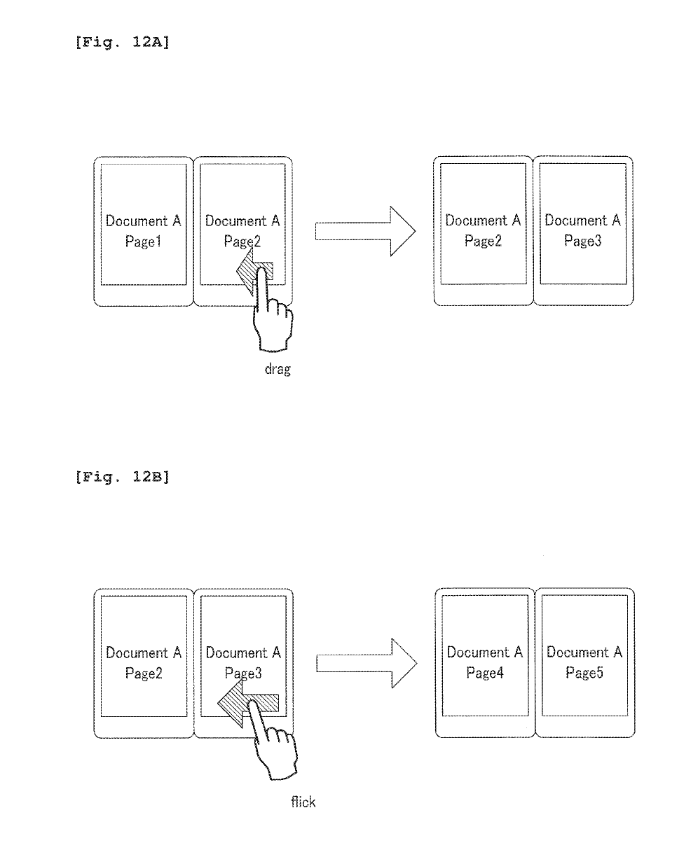

FIGS. 12A and 12B illustrate an exemplary operation according to the present embodiment of the information processing apparatus A (101a) and the information processing apparatus B (101b) of the state shown in FIG. 11B, and a result thereof. If the user performs the drag operation on the information processing apparatus B (or maybe on the information processing apparatus A), the operation is reflected in both the information processing apparatus A and the information processing apparatus B, and thereby page 2 of the document A is displayed in the information processing apparatus A and page 3 of the document A is displayed in the information processing apparatus B (FIG. 12A). Subsequently, if the user performs the flick operation, which turns the page, to the information processing apparatus B (or maybe to the information processing apparatus A), the operation is reflected in both the information processing apparatus A and the information processing apparatus B. The flick operation is regarded as two flick operations to the whole displayed pages 2 and 3, and thereby the page 4 of the document A is displayed in the information processing apparatus A and the page 5 of the document A is displayed in the information processing apparatus B (FIG. 12B). In other words, when the information processing apparatus B accepts the flick operation, it is determined that the flick operation has been performed twice, and the page corresponding to the next or the previous spread state content of the displayed content is reflected in the screen.

As described above, according to the present embodiment, when the user confirms and compares contents by using the two information processing apparatuses, the user does not need to perform the operation of turning pages of the information processing apparatuses. Furthermore, it is possible to turn pages in the same way as turning pages of the conventional book, so that an information processing apparatus system with higher operability can be provided.

### Third Embodiment

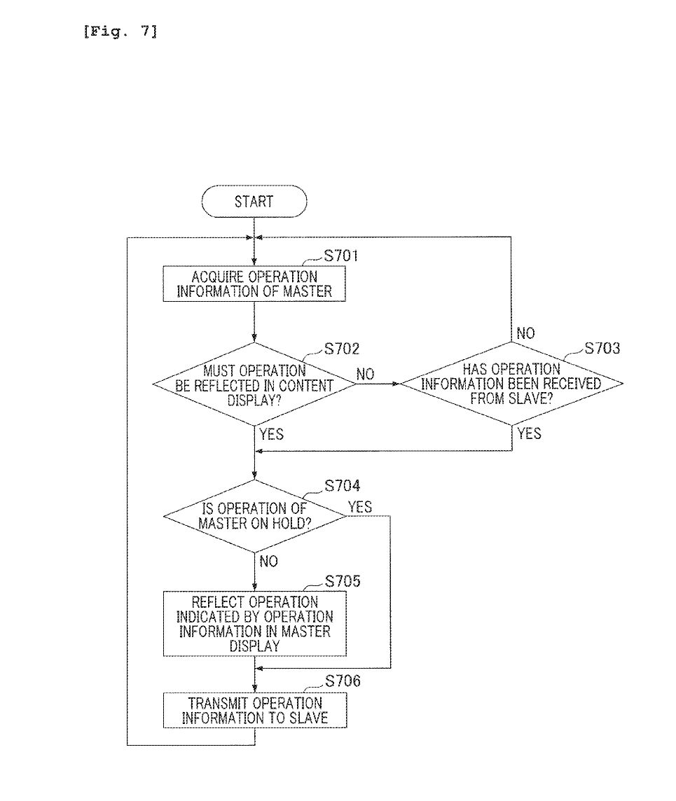

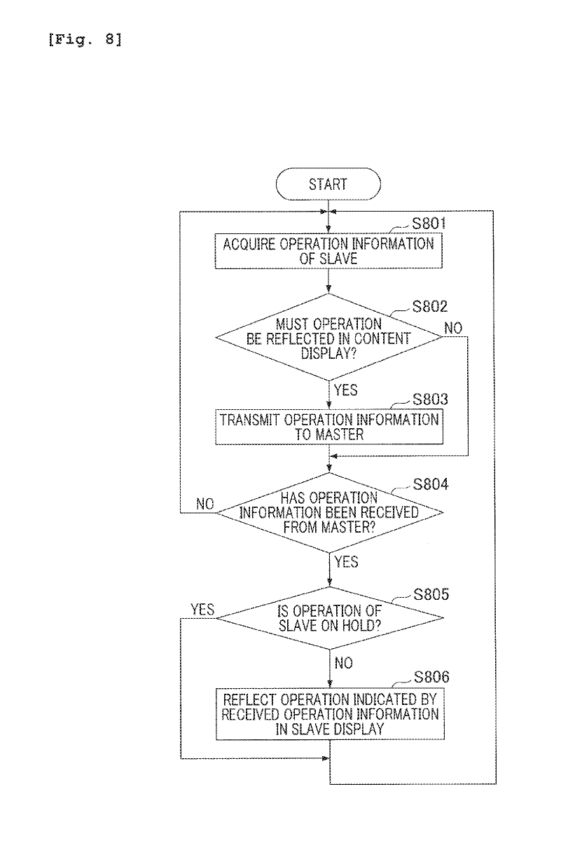

FIGS. 7 and 8 are flowcharts the illustrating operations of the information processing apparatus A (101a), which is the master in the present embodiment, and the information processing apparatus B (101b), which is the slave in the present embodiment. Since the operation in relation to the connection between the information processing apparatus A and the information processing apparatus B is the same as that described in the first or the second embodiment, the explanation thereof will be omitted. In step S701, the cooperative control unit 201a acquires the operation information of the operation information management unit 202a. In step S702, the cooperative control unit 201a determines whether or not the acquired operation information is an operation that must be reflected in the content display. If the acquired operation information is the operation that must be reflected in the content display, the operation proceeds to step S704. If the acquired operation information is not the operation that is required to be reflected in the content display, the operation proceeds to step S703.

In step S703, the cooperative control unit 201a confirms whether the operation information has been received from the slave cooperative control unit 201b of the connection destination. The description will be given of the operation to which the slave cooperative control unit 201b transmits the operation information in the flowchart shown in FIG. 8.

When the operation information has been received from the cooperative control unit 201b, the operation proceeds to step S704. When the operation information has not been received from the cooperative control unit 201b, the operation returns to step S701. In step S704, the cooperative control unit 201a confirms whether or not the operation information of the operation information management unit 202a is a hold operation, which indicates holding the page. If the operation is the hold operation, the operation proceeds to step S706. Otherwise, the operation proceeds to step S705.

In step S705, the cooperative control unit 201a transmits the operation information to the display information management unit 203a. The display information management unit 203a reflects the transmitted operation information to the content display software 204a. The operation of the present step enables the content display software 204a, which operates on the information processing apparatus, A to be reflected the operation of both information processing apparatuses A and B. In step S706, the cooperative control unit 201a transmits the operation information to the slave cooperative control unit 201b of the connection destination.

Next, a description will be given for the operation of the slave information processing apparatus B with reference to the flowchart shown in FIG. 8. In step S801, the cooperative control unit 201b acquires the operation information of the operation information management unit 202b. In step S802, the cooperative control unit 201b determines whether or not the acquired operation information is an operation must be reflected in the content display. If the acquired operation information is the operation must be reflected in the content display, the operation proceeds to step S803. If the acquired operation information is not the operation that is required to be reflect in the content display, the operation proceeds to step S804.

In step S803, the cooperative control unit 201b transmits the operation information acquired in step S801 to the master cooperative control unit 201a of the connection destination. The operation information transmitted by the cooperative control unit 201b in the present step is received by the cooperative control unit 201a in step S703 shown in FIG. 7. In step S804, the cooperative control unit 201b confirms whether the operation information is received from the master cooperative control unit 201a of the connection destination. The operation information transmitted by the cooperative control unit 201a in step S706 shown in FIG. 7 is received by the cooperative control unit 201b in the present step. If the operation information has been received from the cooperative control unit 201a, the operation proceeds to step S805. If the operation information has not been received from the cooperative control unit 201a, the operation returns to step S801.

In step S805, the cooperative control unit 201b confirms whether or not the operation information of the operation information management unit 202b is a hold operation, which indicates holding the page. If the operation is the hold operation, the operation returns to step S801. Otherwise, the operation proceeds to step S806. In step S806, the cooperative control unit 201b transmits the operation information received in step S804 to the display information management unit 203b. The display information management unit 203b reflects the transmitted operation information in the content display software 204b. The operation of the present step enables the content display software 204b which operates on the information processing apparatus B to be reflected the operation of both information processing apparatuses A and B.

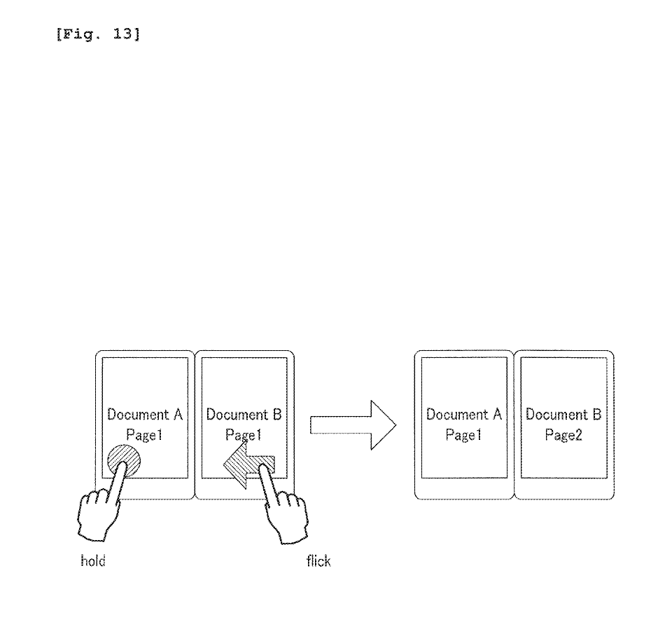

FIG. 13 illustrates an exemplary operation according to the present embodiment of the information processing apparatus A (101a) and the information processing apparatus B (101b) in the state shown in FIG. 9B, and a result thereof. If the user performs the hold operation on the information processing apparatus A, and then perform flick operation, which turns the page, on the information processing apparatus B, and the information processing apparatus A keeps on displaying the page 1 of the document A and the information processing apparatus B displays the page 2 of the document B.

As described above, according to the present embodiment, to change a display of content while a display of other certain content remains is realized by an intuitive operation. In addition to the operability of the first and the second embodiments, the information processing apparatus system with higher operability can be provided to the users.

While the information processing system according to the present invention has been described through the specification with reference to exemplary embodiments of having two information processing apparatuses, it is to be understood that the invention is not limited to the disclosed exemplary embodiments. For example, three or more information processing apparatuses can cooperatively display by cooperating. In this case, one information processing apparatus functions as a master and the remaining information processing apparatuses function as slaves. If an operation instruction has been performed via a touch panel on any screen of the slave devices, the master device waits for the operation information from all of the slave devices, in step S307 shown in FIG. 3. Then in step S308, the operation indicated by the operation information may be reflected on the screen of the master device and in step S309 the operation information may be transmitted to all of the slave devices at the same time. By this configuration, the slave device need not to wait for the operation information from the other slave devices and only waits for the operation information from the master device, and thereby the cooperative process is realized by a simple configuration.

Furthermore, while the configuration of the information processing system according to the present invention has been described through the specification that the two information processing apparatuses have been arranged in horizontal direction, it is to be understood that the invention is not limited to the disclosed configuration. For example, the respective apparatuses may be placed in lateral direction and the apparatuses may be arranged in vertical direction, or one device may display the content in vertical direction and the other display the content in horizontal direction.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)(trademark)), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-212228 filed Oct. 9, 2013, which is hereby incorporated by reference herein in its entirety.

1. A first information processing apparatus including a first touch panel, the first information processing apparatus comprising:
an accepting unit configured to accept a touch operation to switch a page of content displayed on the first touch panel; and
a controlling unit configured to switch the page of the content displayed on the first touch panel in accordance with accepting the touch operation by the accepting unit and to transmit information to a second information processing apparatus including a second touch panel for switching a page of a content displayed on the second touch panel.

2. The first information processing apparatus according to claim 1, further comprising:
a receiving unit configured to receive information indicating that the touch operation to switch the page of the content displayed on the second touch panel is performed from the second information processing apparatus,
wherein the controlling unit switches the page of the content displayed on the first touch panel in accordance with receiving the information by the receiving unit.

3. The first information processing apparatus according to claim 2, wherein the controlling unit transmits the information to the second information processing apparatus for switching the page of the content displayed on the second touch panel in accordance with receiving the information by the receiving unit.

4. The first information processing apparatus according to claim 1, wherein, in case that the content displayed on the first touch panel and the content displayed on the second touch panel are the same content and the touch operation accepted by the accepting unit is a flick operation, the controlling unit switches the page of the content displayed on the first touch panel for 2 pages and transmits the information to the second information processing apparatus including the second touch panel for switching the page of the content displayed on the second touch panel for 2 pages.

5. The first information processing apparatus according to claim 4, wherein, in case that the touch operation accepted by the accepting unit is a drag operation, the controlling unit switches the page of the content displayed on the first touch panel for 1 page and transmits the information to the second information processing apparatus including the second touch panel for switching the page of the content displayed on the second touch panel for 1 page, regardless of whether the content displayed on the first touch panel and the content displayed on the second touch panel are the same content or not.

6. The first information processing apparatus according to claim 1, further comprising:
a determining unit configured to determine which of the first information processing apparatus or the second information processing apparatus should become a master or a slave,
wherein, in case that the first information processing apparatus is determined to become the master by the determining unit, the controlling unit carries out control to switch the page of the content displayed on the first touch panel and to transmit the information to the second information processing apparatus including the second touch panel for switching the page of the content displayed on the second touch panel for 1 page, in accordance with accepting the touch operation by the accepting unit,
wherein, in case that the first information processing apparatus is determined to become the slave by the determining unit, the controlling unit carries not control in which the page of the content displayed on the first touch panel is not switched even if the touch operation is accepted by the accepting unit and in which the page of the content displayed on the first touch panel is switched in accordance with receiving an instruction for switching the page from the second information processing apparatus.

7. A control method for controlling a first information processing apparatus including a first touch panel, the method comprising:
accepting a touch operation to switch a page of a content displayed on the first touch panel; and
switching the page of the content displayed on the first touch panel in accordance with accepting the touch operation by the accepting unit and transmitting information to a second information processing apparatus including a second touch panel for switching a page of a content displayed on the second touch panel.

8. A non-transitory storage medium on which is stored a computer program for making a computer execute a control method for controlling a first information processing apparatus including a first touch panel, the method comprising:
accepting a touch operation to switch a page of a content displayed on the first touch panel; and
switching the page of the content displayed on the first touch panel in accordance with accepting the touch operation by the accepting unit and transmitting information to a second information processing apparatus including a second touch panel for switching a page of a content displayed on the second touch panel.
